(19) United States
(12) Patent Application Publication
(10) Pub. No.: US 2023/0254919 A1
(43) Pub. Date: Aug. 10, 2023

(54) MULTI-LINK TRANSMISSION IN A WIRELESS NETWORK

(71) Applicant: Telefonaktiebolaget LM Ericsson (publ), Stockholm (SE)

(72) Inventors: Leif WILHELMSSON, Lund (SE); Rocco DI TARANTO, Lund (SE); Narendar MADHAVAN, Bara (SE)

(21) Appl. No.: 18/004,725

(22) PCT Filed: Jul. 10, 2020
(86) PCT No.: PCT/EP2020/069598

§ 371 Date: Jan. 9, 2023

(51) Int. Cl. H04W 76/15; H04W 36/32; H04W 36/18

(52) U.S. Cl. CPC H04W 76/15; H04W 36/32; H04W 36/18

(57) ABSTRACT

A system for multi-link transmission in a wireless network having multiple nodes. Each node defines a corresponding coverage area and is configured to perform operations in the wireless network. The system has a device configured to transition between nodes and corresponding coverage areas and perform operations in the wireless network, a controller causing transmission of data between the device and a set of nodes using a multi-link connection. The multi-link includes a first transmission link and a second transmission link associating the device with the node set. The controller causes transmission of data over the first transmission link and/or the second transmission link. The same frequency and same cell identifier is allocated to the node set for transmission of data in the first transmission link. Different cell identifiers are allocated to respective node in the node set for transmission of data in the second transmission link.

### TECHNICAL FIELD

The present disclosure relates generally to the field of wireless communication. More particularly, it relates to multi-link transmission in a wireless network.

### BACKGROUND

There is an increased interest in using unlicensed bands due to their many desirable properties. One of these properties is the very large amount of available spectrum, especially with the recent ruling of the Federal Communications Commission, where another 1.2 GHz of spectrum is made available between 5.9 and 7.1 GHz.

One approach to take advantage of the large bandwidth is to support multi-link transmission. In multi-link transmission, more than one channel may be used concurrently to increase the total data rate that can be supported. However, increasing the supported bandwidth has the disadvantage of increased implementation complexity e.g. in terms of the analog-to-digital-converter (ADC) implementation.

In spite of the large available bandwidth, operation in unlicensed bands are also associated with difficulties. Since the operation is unlicensed, there may be interfering devices so that it may be hard to ensure high quality of service (QoS), e.g. high reliability and guaranteed low latency. Another disadvantage commonly associated with, e.g., Wi-Fi is poor support for mobility, i.e., the ability to perform a smooth hand-over from one cell to another.

The IEEE 802.11 working group has recently begun development of an enhancement called Extremely High Throughput (EHT). The enhancement EHT introduces new features, and one of these new features is multi-link operation (reference to Compendium of straw polls and potential changes to the Specification Framework Document in IEEE P802.11 Wireless LAN https://mentor.ieee.org/802.11/dcn/20/11-20-0566-23-00be-compendium-of-straw-polls-and-potential-changes-to-the-specification-framework-document.docx).

Taking IEEE 802.11be (IEEE 802.11 EHT) as an example, which supports a maximum bandwidth of 320 MHz, it may not be so easy to actually find 320 MHz that is sufficiently free from interference and thus feasible to use.

The somewhat limited ability to support mobility in Wi-Fi networks implies that, e.g., Internet of Things applications with more demanding mobility requirements cannot be supported in spite of a very large available bandwidth and also in spite of the ability to support very high data rates and multi-link operation.

Therefore, there is a need for approaches for multi-link transmission in a wireless network.

### SUMMARY

It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an apparatus is referred to herein, it is to be understood as a physical product. The physical product may comprise one or more parts, such as controlling circuitry in the form of one or more controllers, one or more processors, or the like.

It is an object of some embodiments to solve or mitigate, alleviate, or eliminate at least some of the above or other drawbacks.

According to a first aspect, this is achieved by a system for multi-link transmission in a wireless network comprising multiple nodes, wherein each node defines a corresponding coverage area and is configured to perform operations in the wireless network.

The system comprises a device configured to transition between nodes and corresponding coverage areas and perform operations in the wireless network.

The system further comprises a controller configured to cause transmission of data between the device and a set of nodes using a multi-link connection, wherein the multi-link comprises a first transmission link and a second transmission link associating the device with the set of nodes.

The controller is further configured to cause transmission of data over the first transmission link and/or the second transmission link, wherein a same frequency and a same cell identifier is allocated to the set of nodes for the transmission of data in the first transmission link, and wherein different cell identifiers are allocated to respective node in the set of nodes for the transmission of data in the second transmission link.

In some embodiments, the controller is further configured to cause transmission of data over the first transmission link and/or the second transmission link depending on the operations to be performed, wherein the first transmission link is configured to be used for operations with critical time requirements, and wherein the second transmission link is configured to be used for operations with non-critical time requirements.

In some embodiments, the first transmission link is configured to be used for mobility operations when the device is transitioning from a coverage area of one node into a coverage area of a neighbouring node in the set of nodes.

In some embodiments, the mobility operations comprise handover between nodes in the set of nodes.

In some embodiments, the critical time requirements comprise hard time requirements for enabling a seamless handover between nodes in the set of nodes.

In some embodiments, the second transmission link is configured to be used for operations when the device is transmitting data independently in a coverage area of one node in the set of nodes.

In some embodiments, the first transmission link and the second transmission link are configured to be used in parallel depending on the operations to be performed.

In some embodiments, the first transmission link is scalable depending on the operations to be performed.

In some embodiments, the controller is further configured to determine the operations to be performed by the device and/or the set of nodes.

In some embodiments, the controller is further configured to allocate an amount of bandwidth to respective node in the set of nodes based on the operations to be performed.

In some embodiments, the controller is comprised in the wireless network and associated to the device and the set of nodes.

In some embodiments, the device and the set of nodes are configured to signal their multi-link multi-node capabilities to other devices and nodes in the wireless network.

In some embodiments, the device comprises a station, STA.

In some embodiments, the set of nodes comprise access points, AP.

In some embodiments, the wireless network is configured for Wi-Fi.

A second aspect is an apparatus for multi-link transmission in a wireless network comprising a device and multiple nodes, wherein each node defines a corresponding coverage area and is configured to perform operations in the wireless network and the device is configured to transition between the nodes and corresponding coverage areas and perform operations in the wireless network.

The apparatus is configured to cause transmission of data between the device and a set of the nodes using a multi-link connection, wherein the multi-link comprises a first transmission link and a second transmission link associating the device with the set of nodes.

The apparatus is further configured to cause usage of the first transmission link and/or the second transmission link, wherein a same frequency and a same cell identifier is allocated to the set of nodes for the transmission of data in the first transmission link, and wherein different cell identifiers are allocated to respective node in the set of nodes for the transmission of data in the second transmission link.

In some embodiments, the apparatus is further configured to cause transmission of data over the first transmission link and/or the second transmission link depending on the operations to be performed, wherein the first transmission link is configured to be used for operations with critical time requirements, and wherein the second transmission link is configured to be used for operations with non-critical time requirements.

In some embodiments, the first transmission link is configured to be used for mobility operations when the device is transitioning from a coverage area of one node into a coverage area of a neighboring node in the set of nodes.

In some embodiments, the mobility operations comprise handover between nodes in the set of nodes.

In some embodiments, the critical time requirements comprise hard time requirements for enabling a seamless handover between nodes in the set of nodes.

In some embodiments, the second transmission link is configured to be used for operations when the device is transmitting data independently in a coverage area of one node in the set of nodes.

In some embodiments, the first transmission link and the second transmission link are configured to be used in parallel depending on the operations to be performed.

In some embodiments, the first transmission link is scalable depending on the operations to be performed.

In some embodiments, the apparatus is further configured to cause determination of the operations to be performed by the device and/or the set of nodes.

In some embodiments, the apparatus is further configured to cause allocation of an amount of bandwidth to respective node in the set of nodes based on the operations to be performed.

In some embodiments, the apparatus is comprised in the wireless network and associated to the device and the set of nodes.

In some embodiments, the device and the set of nodes are configured to signal their multi-link multi-node capabilities to other devices and nodes in the wireless network.

A third aspect is a node comprising the apparatus according to the second aspect.

A fourth aspect is a method for multi-link transmission in a wireless network comprising a device and multiple nodes, wherein each node defines a corresponding coverage area and is configured to perform operations in the wireless network and the device is configured to transition between the nodes and corresponding coverage areas and perform operations in the wireless network.

The method comprises transmitting data between the device and a set of the nodes using a multi-link connection, wherein the multi-link comprises a first transmission link and a second transmission link associating the device with the set of nodes.

The method further comprises using the first transmission link and/or the second transmission link, wherein a same frequency and a same cell identifier is allocated to the set of nodes for the transmission of data in the first transmission link, and wherein different cell identifiers are allocated to respective node in the set of nodes for the transmission of data in the second transmission link.

In some embodiments, the method further comprises using the first transmission link and/or the second transmission link depending on the operations to be performed, wherein the first transmission link is configured to be used for operations with critical time requirements, and wherein the second transmission link is configured to be used for operations with non-critical time requirements.

In some embodiments, the first transmission link is configured to be used for mobility operations when the device is transitioning from a coverage area of one node into a coverage area of a neighboring node in the set of nodes.

In some embodiments, the mobility operations comprise handover between nodes in the set of nodes.

In some embodiments, the critical time requirements comprise hard time requirements for enabling a seamless handover between nodes in the set of nodes.

In some embodiments, the second transmission link is configured to be used for operations when the device is transmitting data independently in a coverage area of one node in the set of nodes.

In some embodiments, the first transmission link and the second transmission link are configured to be used in parallel depending on the operations to be performed.

In some embodiments, the first transmission link is scalable depending on the operations to be performed.

In some embodiments, the method further comprises determining the operations to be performed by the device and/or the set of nodes.

In some embodiments, the method further comprises allocating an amount of bandwidth to respective node in the set of nodes based on the operations to be performed.

In some embodiments, the device and the set of nodes are configured to signal their multi-link multi-node capabilities to other devices and nodes in the wireless network.

A fifth aspect is a computer program product comprising a non-transitory computer readable medium, having thereon a computer program comprising program instructions. The computer program is loadable into a data processing unit and configured to cause execution of the method according to the fourth aspect when the computer program is run by the data processing unit.

Any of the above aspects may additionally have features identical with or corresponding to any of the various features as explained above for any of the other aspects.

An advantage of some embodiments is that approaches for multi-link transmission in a wireless network are provided.

An advantage of some embodiments is that multi-link transmission provides a good mobility support by deploying a wireless network in which the multi-link capabilities are explored to obtain a wireless network both supporting very high data rate and good mobility, wherein frequency planning and multi-link support are combined such that one channel is commonly used in all cells to support seamless mobility by allocating one of the links to this channel when mobility is needed and allocate the other link(s) to other channel(s) to support high data rate by using a channel that is as far as possible not used by neighboring cells.

An advantage of some embodiments is that multi-link transmission allows for increasing the total bandwidth in a more modular approach.

An advantage of some embodiments is that multi-link transmission provides for more flexibility in supporting both very high data rate and good mobility.

An advantage of some embodiments is that seamless connectivity across multiple nodes in a wireless network is provided.

An advantage of some embodiments is that reliability and robustness in connectivity across multiple nodes in a wireless network is provided.

It should be noted that, even if embodiments are described herein in the context of multi-link transmission in a wireless network, some embodiments may be equally applicable and/or beneficial also in other contexts.

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a flowchart illustrating example method steps according to some embodiments;

FIG. 2a is a schematic drawing illustrating example cell configuration according to some embodiments;

FIG. 2b is a schematic drawing illustrating example cell configuration according to some embodiments;

FIG. 3a is a schematic drawing illustrating example cell configuration according to some embodiments;

FIG. 3b is a schematic drawing illustrating example cell configuration according to some embodiments;

FIG. 4 is a schematic drawing illustrating example cell configuration according to some embodiments;

FIG. 5 is a schematic block diagram illustrating an example apparatus according to some embodiments; and

FIG. 6 is a schematic drawing illustrating an example computer readable medium according to some embodiments.

### DETAILED DESCRIPTION

As already mentioned above, it should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

As mentioned above, the IEEE 802.11 working group has begun development of EHT, wherein EHT introduces new features, and one of these new features being multi-link operation, hereinafter simply referred to as multi-link.

The purpose of multi-link is to enable a device to operate and send data on multiple links simultaneously or semi-simultaneously, depending on its capability to transmit and receive simultaneously.

Multi-link aims to enable aggregation of bandwidth as well as lower latency through faster channel access.

In the following, embodiments will be presented where approaches for multi-link transmission in a wireless network are described.

Generally, even if exemplification is made using a context for IEEE 802.11, it should be noted that some embodiments are equally applicable in other contexts, e.g., multi-link within a context of Third Generation Partnership Project (3GPP) standards.

Node, as described herein, may typically comprise a node in a wireless network, wherein the node may typically comprise an access point (AP).

For example, an AP may comprise a base station, or stand-alone device that may be plugged into a router or switch etc.

Device, as described herein, may typically comprise a station (STA) or a fixed, mobile, or portable client device that has the capability to use the IEEE 802.11 protocol.

For example, a STA may be a computer, laptop, or smart phone etc.

It should be noted that, even if embodiments are described herein in the context of seamless connectivity across multiple nodes in a wireless network by multi-link transmission, some embodiments may be equally applicable and/or beneficial also in other contexts of multi-link transmission in a wireless network.

It should further be noted that, even if embodiments are described herein in the context of a device being connected to a first node and a second node in a wireless network, some embodiments may be equally applicable and/or beneficial also in other contexts wherein the device is connected to multiple nodes in the wireless network.

Embodiments herein are described when applied to systems based on IEEE 802.11, also commonly referred to as Wi-Fi.

The node will herein be denoted AP and a device connected to an AP will be denoted STA.

It will also initially be assumed that all APs and all STAs are multi-link capable, i.e., are able to operate on two channels concurrently.

Multi-link operation, as described herein, typically comprises both synchronous and asynchronous operation. Asynchronous operation means that the operation on two channels can be done without any care have to be taken, whereas synchronous operation means that there are restrictions concerning whether the two links need to be both transmitting or receiving, i.e., one cannot be transmitting while the other is receiving. Effectively, in case of asynchronous operation, sufficient filtering between the two links is achieved so that transmitting on one link does not cause any (noticeable) degradation on reception on the other link. Embodiments of the invention do not rely on this and the embodiments of the invention are applicable regardless of whether the operation is synchronous or asynchronous. Unless specifically stated otherwise, it will be assumed that all devices support asynchronous operation.

As mentioned above, the very large available bandwidth presents desirable properties and especially for Industrial Internet of Things (IIoT). IIoT is an emerging use of wireless communication in unlicensed bands, wherein it may be possible to control the wireless environment such that interference from other devices may be avoided. Specifically, it may be possible to deploy a network within a factory where uncontrolled interference can be avoided by, e.g., banning the use of certain frequencies and move potential interfering devices to another channel. However, IIoT is envisioned to require that mobility can be handled efficiently as various machines may be moving throughout the facilities and it may also be needed to move devices from one cell to another as a means to do load balancing.

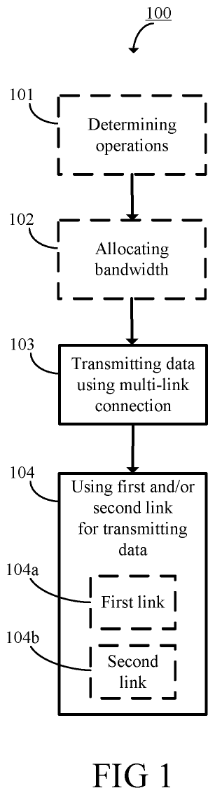

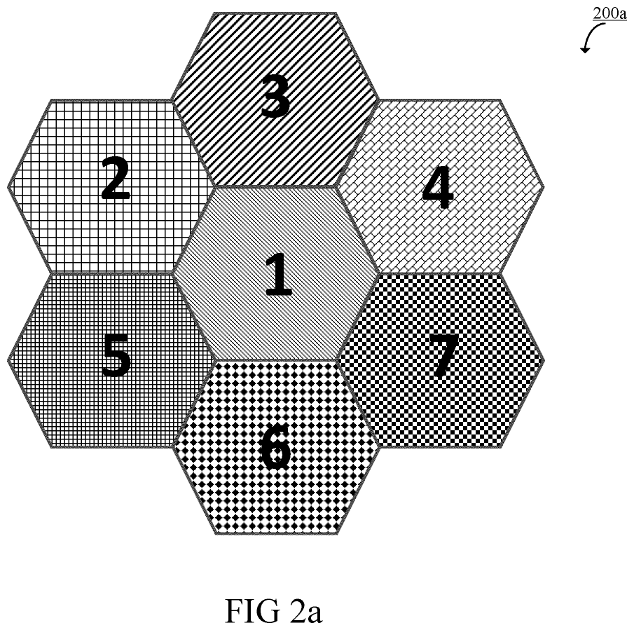

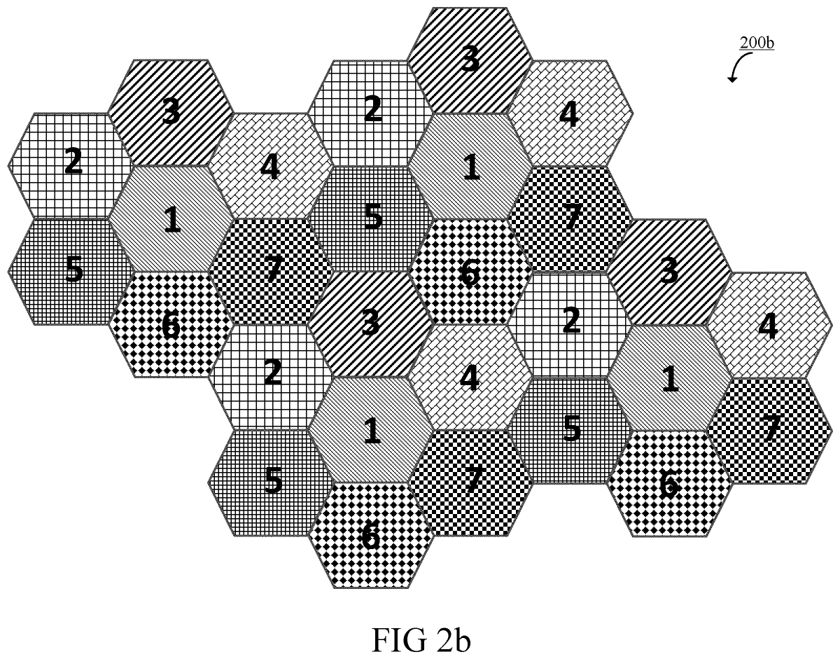

FIG. 1 is a flowchart illustrating method steps of an example method 100 according to some embodiments. The method 100 is for multi-link transmission in a wireless network comprising a device and multiple nodes, wherein each node defines a corresponding coverage area and is configured to perform operations in the wireless network and the device is configured to transition between the nodes and corresponding coverage areas and perform operations in the wireless network. Thus, the method 100 (or steps thereof) may, for example, be performed by the apparatus 500 and/or the controller 510 of FIG. 5 in cell configurations of FIGS. 2-4; all of which will be described later herein.

The method 100 comprises the following steps.

In optional step 101, in some embodiments, the operations to be performed are determined by the device and/or the set of nodes.

In optional step 102, in some embodiments, an amount of bandwidth is allocated to respective node in the set of nodes based on the operations to be performed.

In step 103, data is transmitted between the device and a set of the nodes using a multi-link connection, wherein the multi-link comprises a first transmission link and a second transmission link associating the device with the set of nodes.

In step 104, the first transmission link and/or the second transmission link is used, wherein a same frequency and a same cell identifier is allocated to the set of nodes for the transmission of data in the first transmission link, and wherein different cell identifiers are allocated to respective node in the set of nodes for the transmission of data in the second transmission link.

In some embodiments, the first transmission link and/or the second transmission link is used depending on the operations to be performed, wherein the first transmission link is configured to be used for operations with critical time requirements, and wherein the second transmission link is configured to be used for operations with non-critical time requirements.

It can be noted that a transmission may have more or less time critical requirements depending on the context. For example, say that an application is on the border, and if there is no other device moving around, this application may then be allocated to the first link. On the other hand, if there are plenty of applications really needing the first link, maybe one has to accept using the second link.

In optional step 104a, in some embodiments, the first transmission link is used for operations with critical time requirements.

For example, the first transmission link is configured to be used for mobility operations when the device is transitioning from a coverage area of one node into a coverage area of a neighbouring node in the set of nodes.

For example, the mobility operations comprise handover between nodes in the set of nodes.

For example, the critical time requirements comprise hard time requirements for enabling a seamless handover between nodes in the set of nodes.

In optional step 104b, in some embodiments, the second transmission link is used for operations with non-critical time requirements.

For example, the second transmission link is configured to be used for operations when the device is transmitting data independently in a coverage area of one node in the set of nodes.

In some embodiments, the first transmission link and the second transmission link are configured to be used in parallel depending on the operations to be performed.

In some embodiments, the first transmission link is scalable depending on the operations to be performed.

Alternatively or additionally, a corresponding adjustment in bandwidth is performed where the first transmission link is suitably scaled. In some embodiments, the device and the set of nodes are configured to signal their multi-link multi-node capabilities to other devices and nodes in the wireless network.

Any of the above steps for FIG. 1 may additionally have features which are identical with or corresponding to any of the various features as explained below as suitable.

FIGS. 2a and 2b are schematic drawings illustrating example cell configurations 200a and 200b according to some embodiments. The cell configurations 200a and 200b are for multi-link transmission in a wireless network comprising multiple nodes, wherein each node defines a corresponding coverage area and is configured to perform operations in the wireless network.

FIG. 2a illustrates how different cells may split the total available bandwidth into 7 different channels to minimize co-channel interference.

Typically, in controlled Wi-Fi deployments, e.g., installations in an enterprise, a factory, or an airport, a large number of APs are placed somewhat regularly so that an arbitrary placed STA in the coverage area will have at least one AP that is close enough to provide high enough signal strength for both the downlink (DL) and the uplink (UL) and also to ensure that not too many STAs must be supported by the same AP. In order to avoid that neighboring APs cause too much interference to one another, the network is frequency planned so that neighboring APs use different frequency channels, which is illustrated in FIG. 2a.

In FIG. 2a, the total available bandwidth is shared between seven APs. The total available bandwidth may be, e.g., 560 MHz, and this may then be divided such that each of the seven APs uses an 80 MHz channel.

Alternatively or additionally, the total bandwidth is divided so that some of the APs have a wider channel than others, and where the bandwidth allocated to the different APs may be based on the expected traffic that respective AP will have to support.

When a STA moves around, e.g. from the coverage area of AP1 to the coverage area of AP3, it will change channel from the one used by AP1 to the one used by AP3.

FIG. 2b illustrates how the different frequencies may be allocated when there is a need to reuse a pattern of different cells with different channels to minimize co-channel interference.

In small facilities, the total bandwidth may be sufficiently large to be divided among all the APs needed to provide coverage, and if this is the case co-channel interference can be completely avoided. However, when the number of APs increases and/or the bandwidth needed for the APs is increased then the same frequency must be reused in what is commonly referred to as a reuse pattern, which is illustrated in FIG. 2b.

In FIG. 2b, there are in total 28 APs, and as can be seen the same frequency is used by four APs. As can be noted in the illustration, the deployment is such that no neighboring cells use the same frequency and in this way the co-channel interference can be controlled to some extent.

If a STA is moving around in a large facility, it may thus do frequency handover many times and even return to the same frequency but be connected to another AP.

Doing handover between cells is usually not a big issue when there are no hard requirements on delay, as it then may be fine to even completely break the connection and set up a new one. However, when there are strict (i.e., critical) requirements, one may need to ensure that the handover from one AP to another AP is seamless, e.g., it is not noticeable for the application.

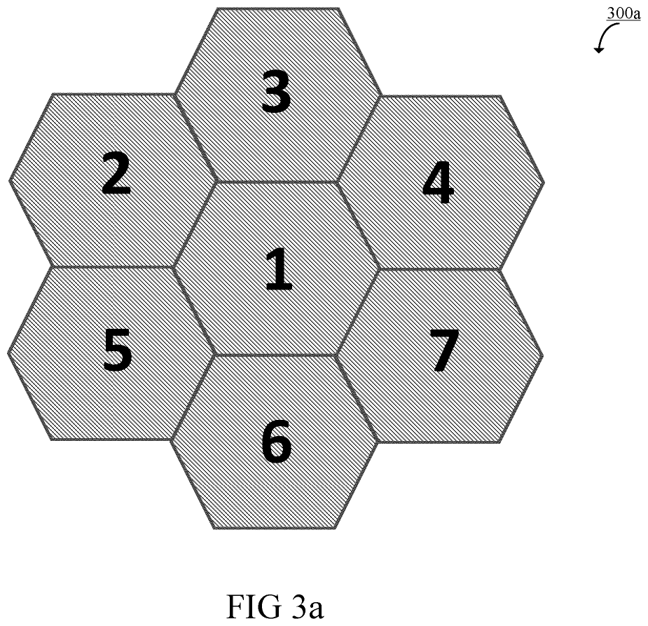

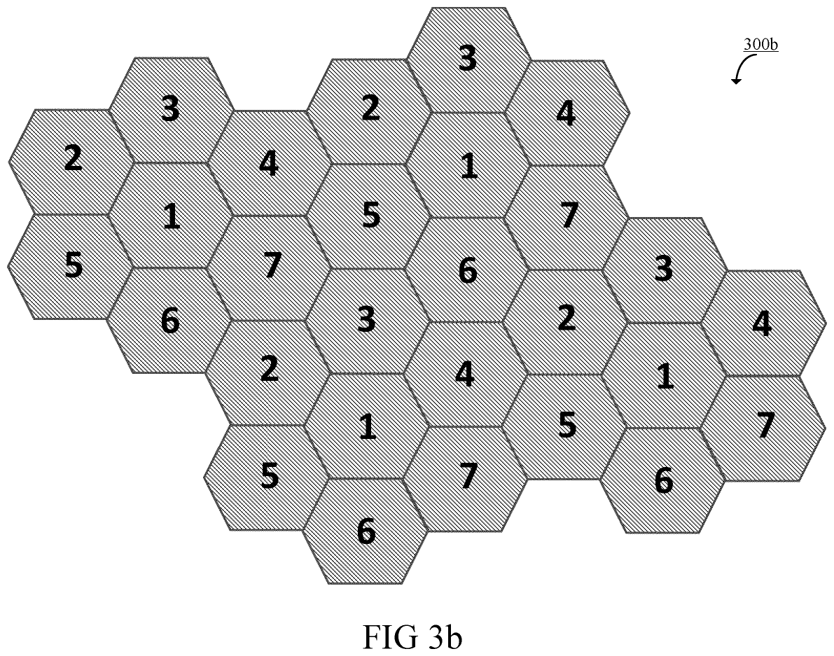

FIGS. 3a and 3b are schematic drawings illustrating example cell configurations 300a and 300b according to some embodiments. The cell configurations 300a and 300b are for multi-link transmission in a wireless network comprising multiple nodes, wherein each node defines a corresponding coverage area and is configured to perform operations in the wireless network.

FIG. 3a illustrates how the same frequency is used by adjacent APs in order to provide seamless handover, wherein the APs use the same cell identifier (SSID, service set identifier) and the same basic service set identifier (BSSID), i.e., the same MAC address.

One approach to achieve such a seamless operation is to take a completely different approach when it comes to frequency planning and make sure that all APs use the same channel. This requires coordination among the APs and of course also means that the total available bandwidth cannot be used since it may be larger than what can be handled by an AP. In addition, the same resource (in time and frequency) cannot be used independently by two neighboring APs.

With this approach, if the APs agree to use the same SSID a STA that moves around will only see a single cell and it will not have to do any handover between APs. Effectively, it will be handled over from one AP to the next, but this is taken care of completely by the network and is transparent for the STA. Using the same AP placement and cell layout as in FIG. 2a, the approach of letting all the APs use the same frequency is illustrated accordingly in FIG. 3a.

With this approach, the total data rate that can be supported becomes limited as the same data is sent from all APs in the DL and all APs receive the same data sent in the UL. This is the purpose of making it look like it is only one single cell when viewed from the STA's side. It can be noted that although it is stated that the same data is sent from all APs, it may be so that only a sub-set of the APs is actively transmitting, while the others are not transmitting anything, and in particular are not transmitting any other data. Referring to FIG. 3a, suppose that a STA is located in the corner of the cells 1, 2, and 3 and that this location is known for the network. In this case, it would typically not make sense to let the APs in cells 4, 5, 6, or 7 to transmit, but only the APs in cells 1, 2, and 3. The APs in cells 4, 5, 6, and 7 would then not transmit to this particular STA.

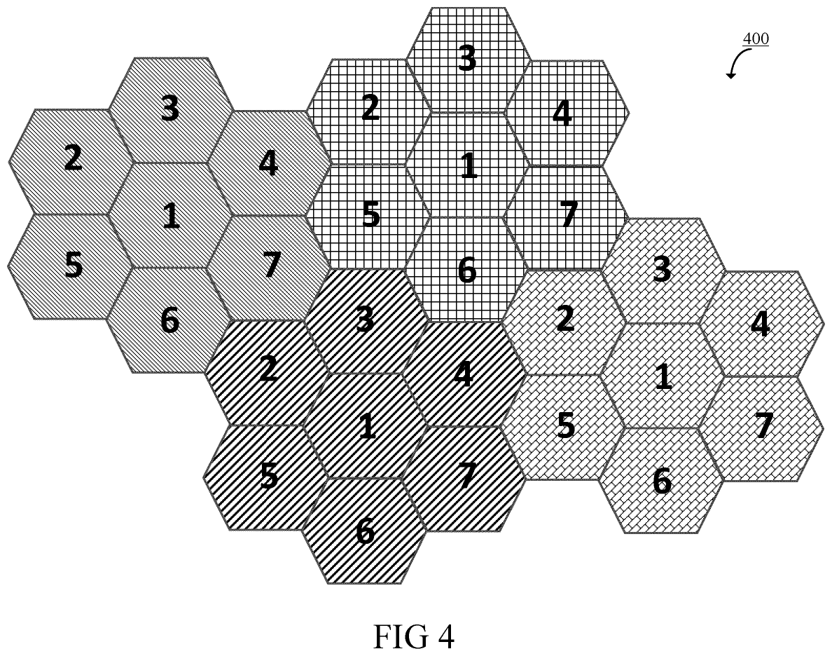

FIG. 4 is a schematic drawing illustrating an example cell configuration 400 according to some embodiments. The cell configuration 400 is for multi-link transmission in a wireless network comprising multiple nodes, wherein each node defines a corresponding coverage area and is configured to perform operations in the wireless network.

FIG. 4 illustrates how different cells may split the total available bandwidth while the same frequency is used by adjacent APs in order to provide seamless handover.

Referring to the discussion above, one may either configure the system to maximize the total data rate that can be supported by doing proper frequency planning (reference to FIGS. 2a and 2b), or one can design a system which appears as a single cell and therefore will achieve very good performance when high requirement mobility must be supported (reference to FIGS. 3a and 3b).

With this approach, the two approaches described and illustrated in FIGS. 2a-b and 3a-b are combined by the use of multi-link operation such that one of the transmission links predominately is used for the bulk of data transfer (i.e., operations with non-critical time requirements), whereas the other transmission link is used to ensure that seamless handover can be obtained when needed (i.e., operations with critical time requirements).

Referring again to FIGS. 2a-b and 3a-b, one transmission link corresponds to the frequency plan illustrated in FIGS. 2a-b, whereas the other transmission link corresponds to the frequency plan illustrated in FIGS. 3a-b.

For example, suppose that 600 MHz is available in total. The APs are then allocated frequencies for Link 2 as discussed in relation to FIGS. 2a-b. This amounts to 560 MHz. The remaining 40 MHz are used for Link 1 by all APs as discussed in relation to FIGS. 3a-b.

In some embodiments, a frequency planning for a network supporting multi-link is provided, wherein at least one of the links is intended to be used when a STA is moving from the coverage area of one of the APs into the coverage area of one of the other APs. This link intended to be used for mobility is characterized by that the same frequency is used by the two neighboring APs. In addition to the link intended for mobility, each of the APs does also support at least one more link on another frequency than the frequency used for the first link. The second link(s) for the respective AP is characterized by that the frequencies used by the different APs for the second link(s) are different in order to allow for them to be used at the same time for transmitting independent data in respective cell.

For example, a selection is also performed for how much of the total bandwidth is allocated to the first link, i.e., the link used for mobility, i.e., for operations with critical time requirements.

For example, a dynamic change of the bandwidth allocated to the first link is provided in that more bandwidth is allocated when there is a greater need to support moving STAs.

For example, signaling the bandwidth/channel allocated to the link used for mobility is also provided to the STA moving from coverage area of one of the APs to the other AP.

The signaling related to the multi-link frequency planning may be performed in different ways.

For example, the availability of a first link suitable for handover can be signaled over the second link, e.g. in management frames such as beacons.

Alternatively or additionally, it may be signaled in the MAC header or signaled using a higher layer protocol.

In some embodiments, a multi-link allocation for mobility is provided, wherein a determination regarding whether to use a first link where the same frequency is used by neighboring APs or a second link where different frequencies are used by neighboring APs is based on whether the STA is close to the cell boundary between the two cells and is expected to move from the coverage area of one of the APs to the coverage area of the other AP. The first link is used when it is expected that a handover is likely, whereas the second link is used otherwise.

For example, a selection of which link to use is provided, wherein the selection is based on the speed of the STA such that the first link is used when the speed is above a threshold value and another link is used if the speed is below the threshold value.

For example, the selection of which link to use is provided, wherein the selection is based on the requirement for a seamless handover such that the first link is selected when there are rather strict requirements on the handover, e.g. in terms of maximum interruption, and where the second link is used when the requirement on handover is more relaxed.

FIG. 5 is a schematic block diagram illustrating an example apparatus 500 according to some embodiments. The apparatus 500 is for multi-link transmission in a wireless network comprising a device and multiple nodes, wherein each node defines a corresponding coverage area and is configured to perform operations in the wireless network and the device is configured to transition between the nodes and corresponding coverage areas and perform operations in the wireless network. Thus, the apparatus 500 may, for example, perform steps of FIG. 1 or otherwise described herein.

The apparatus 500 is configured to cause transmission of data between the device and a set of the nodes using a multi-link connection, wherein the multi-link comprises a first transmission link and a second transmission link associating the device with the set of nodes.

The apparatus 500 is further configured to cause usage of the first transmission link and/or the second transmission link, wherein a same frequency and a same cell identifier is allocated to the set of nodes for the transmission of data in the first transmission link, and wherein different cell identifiers are allocated to respective node in the set of nodes for the transmission of data in the second transmission link.

In some embodiments, the apparatus 500 is further configured to cause transmission of data over the first transmission link and/or the second transmission link depending on the operations to be performed, wherein the first transmission link is configured to be used for operations with critical time requirements, and wherein the second transmission link is configured to be used for operations with non-critical time requirements.

The apparatus 500 may comprise a controller (CNTR; e.g., control circuitry or a controlling module) 510, which may in turn comprise, (or be otherwise associated with; e.g., connected or connectable to), a transmitter 503, e.g., transmitting circuitry or transmitting module, configured to transmit data between the device and a set of the nodes using a multi-link connection, wherein the multi-link comprises a first transmission link and a second transmission link associating the device with the set of nodes (compare with step 103 of FIG. 1).

The controller 510 may further comprise, (or is otherwise associated with; e.g., connected or connectable to), a link user 504, e.g., link using circuitry or link using module, configured to use the first transmission link and/or the second transmission link (compare with step 104 of FIG. 1).

In some embodiments, the controller 510 may furthermore comprise, (or is otherwise associated with; e.g., connected or connectable to), a link user 504a, e.g., link using circuitry or link using module, configured to use the first transmission link (compare with step 104a of FIG. 1).

In some embodiments, the controller 510 may furthermore comprise, (or is otherwise associated with; e.g., connected or connectable to), a link user 504b, e.g., link using circuitry or link using module, configured to use the second transmission link (compare with step 104b of FIG. 1).

In some embodiments, the controller 510 may furthermore comprise, (or is otherwise associated with; e.g., connected or connectable to), a determiner 501, e.g., determining circuitry or determining module, configured to determine the operations to be performed by the device and/or the set of nodes (compare with step 101 of FIG. 1).

In some embodiments, the controller 510 may furthermore comprise, (or is otherwise associated with; e.g., connected or connectable to), an allocator 502, e.g., allocating circuitry or allocating module, configured to allocate an amount of bandwidth to respective node in the set of nodes based on the operations to be performed (compare with step 102 of FIG. 1).

In some embodiments, the controller 510 may furthermore comprise, (or is otherwise associated with; e.g., connected or connectable to), a transceiver TX/RX 520, e.g., transceiving circuitry or transceiving module, configured to transmit and receive information through multi-link transmission in a wireless network.

In some embodiments, the wireless network is configured for Wi-Fi.

In some embodiments, the apparatus 500 and/or the controller 510 is completely or partially comprised in a node and/or in a device.

In some embodiments, the apparatus 500 and/or the controller 510 is completely or partially comprised in in a cloud environment.

Generally, when an apparatus is referred to herein, it is to be understood as a physical product. The physical product may comprise one or more parts, such as controlling circuitry in the form of one or more controllers, one or more processors, or the like.

The described embodiments and their equivalents may be realized in software or hardware or a combination thereof. The embodiments may be performed by general purpose circuitry. Examples of general purpose circuitry include digital signal processors (DSP), central processing units (CPU), Graphics Processing Units (GPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a wireless communication device.

Embodiments may appear within an electronic apparatus (such as a wireless communication device) comprising arrangements, circuitry, and/or logic according to any of the embodiments described herein. Alternatively or additionally, an electronic apparatus (such as a wireless communication device) may be configured to perform methods according to any of the embodiments described herein.

According to some embodiments, a computer program product comprises a computer readable medium such as, for example a universal serial bus (USB) memory, a plug-in card, an embedded drive or a read only memory (ROM).

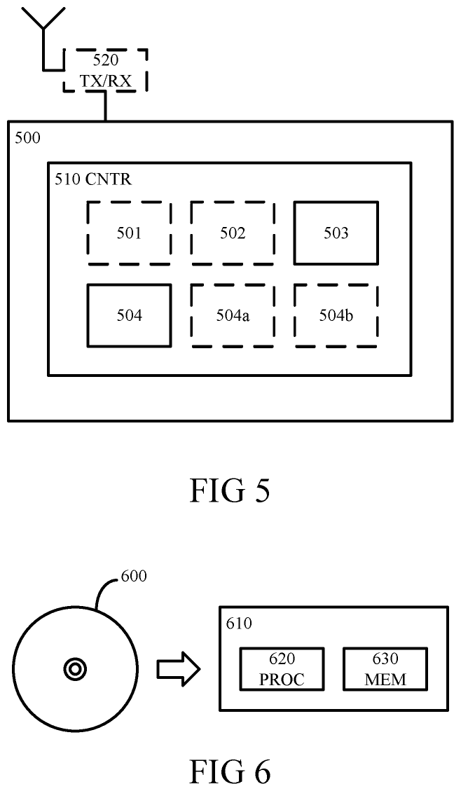

FIG. 6 illustrates an example computer readable medium in the form of a compact disc (CD) ROM 600. The computer readable medium has stored thereon a computer program comprising program instructions. The computer program is loadable into a data processor (PROC) 620, which may, for example, be comprised in a wireless communication device 610. When loaded into the data processor, the computer program may be stored in a memory (MEM) 630 associated with or comprised in the data processor.

In some embodiments, the computer program may, when loaded into and run by the data processing unit, cause execution of steps according to, for example, FIG. 1 and/or one or more of any steps otherwise described herein.

In some embodiments, the computer program may, when loaded into and run by the data processing unit, cause execution of steps according to, for example, FIG. 1 and/or one or more of any steps otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A system for multi-link transmission in a wireless network comprising multiple nodes, each node defining a corresponding coverage area and being configured to perform operations in the wireless network, the system comprising:
a device configured to transition between nodes and corresponding coverage areas and perform operations in the wireless network;
a controller configured to cause transmission of data between the device and a set of nodes using a multi-link connection, the multi-link comprising a first transmission link and a second transmission link associating the device with the set of nodes;
the controller being further configured to cause transmission of data over one or both of the first transmission link and the second transmission link;
a same frequency and a same cell identifier being allocated to the set of nodes for the transmission of data in the first transmission link; and
different cell identifiers being allocated to respective node in the set of nodes for the transmission of data in the second transmission link.

2. The system according to claim 1, wherein the controller is further configured to cause transmission of data over the one or both of the first transmission link and the second transmission link depending on the operations to be performed, wherein the first transmission link is configured to be used for operations with critical time requirements, and wherein the second transmission link is configured to be used for operations with non-critical time requirements.

3. The system according to claim 1, wherein the first transmission link is configured to be used for mobility operations when the device is transitioning from a coverage area of one node into a coverage area of a neighbouring node in the set of nodes.

4. The system according to claim 3, wherein the mobility operations comprise handover between nodes in the set of nodes.

5. The system according to claim 2, wherein the critical time requirements comprise hard time requirements for enabling a seamless handover between nodes in the set of nodes.

6. The system according to claim 1, wherein the second transmission link is configured to be used for operations when the device is transmitting data independently in a coverage area of one node in the set of nodes.

7. The system according to claim 1, wherein the first transmission link and the second transmission link are configured to be used in parallel depending on the operations to be performed.

8. The system according to claim 1, wherein the first transmission link is scalable depending on the operations to be performed.

9. The system according to claim 1, wherein the controller is further configured to determine the operations to be performed by one or both of the device and the set of nodes.

10. The system according to claim 1, wherein the controller is further configured to allocate an amount of bandwidth to respective node in the set of nodes based on the operations to be performed.

11. The system according to claim 1, wherein the controller is comprised in the wireless network and associated to the device and the set of nodes.

12. The system according to claim 1, wherein the device and the set of nodes are configured to signal their multi-link multi-node capabilities to other devices and nodes in the wireless network.

13. The system according to claim 1, wherein one or more of:
the device comprises a station, STA;
the set of nodes comprise access points, AP; and
the wireless network is configured for Wi-Fi.

14. (canceled)

15. (canceled)

16. An apparatus for multi-link transmission in a wireless network comprising a device and multiple nodes, each node defining a corresponding coverage area and being configured to perform operations in the wireless network, the device being configured to transition between the nodes and corresponding coverage areas and perform operations in the wireless network, the apparatus being configured to cause:
transmission of data between the device and a set of the nodes using a multi-link connection, the multi-link comprising a first transmission link and a second transmission link associating the device with the set of nodes;
usage of one or both of the first transmission link and the second transmission link;
a same frequency and a same cell identifier being allocated to the set of nodes for the transmission of data in the first transmission link; and
different cell identifiers being allocated to respective node in the set of nodes for the transmission of data in the second transmission link.

17. The apparatus according to claim 16, wherein the apparatus is further configured to cause transmission of data over the one or both of the first transmission link and the second transmission link depending on the operations to be performed, wherein the first transmission link is configured to be used for operations with critical time requirements, and wherein the second transmission link is configured to be used for operations with non-critical time requirements.

18. The apparatus according to claim 16, wherein the first transmission link is configured to be used for mobility operations when the device is transitioning from a coverage area of one node into a coverage area of a neighbouring node in the set of nodes.

19. The apparatus according to claim 18, wherein the mobility operations comprise handover between nodes in the set of nodes.

20. The apparatus according to claim 17, wherein the critical time requirements comprise hard time requirements for enabling a seamless handover between nodes in the set of nodes.

21. The apparatus according to claim 16, wherein the second transmission link is configured to be used for operations when the device is transmitting data independently in a coverage area of one node in the set of nodes.

22. The apparatus according to claim 16, wherein the first transmission link and the second transmission link are configured to be used in parallel depending on the operations to be performed.

23. The apparatus according to claim 16, wherein the first transmission link is scalable depending on the operations to be performed.

24. The apparatus according to claim 16, wherein the apparatus is further configured to cause determination of the operations to be performed by the one or both of the device and the set of nodes.

25. The apparatus according to claim 16, wherein the apparatus is further configured to cause allocation of an amount of bandwidth to respective node in the set of nodes based on the operations to be performed.

26. The apparatus according to claim 16, wherein the apparatus is comprised in the wireless network and associated to the device and the set of nodes.

27. The apparatus according to claim 16, wherein the device and the set of nodes are configured to signal their multi-link multi-node capabilities to other devices and nodes in the wireless network.

28. (canceled)

29. A method for multi-link transmission in a wireless network comprising a device and multiple nodes, each node defining a corresponding coverage area and being configured to perform operations in the wireless network, the device being configured to transition between the nodes and corresponding coverage areas and perform operations in the wireless network, the method comprising:
transmitting data between the device and a set of the nodes using a multi-link connection, the multi-link comprising a first transmission link and a second transmission link associating the device with the set of nodes;
using the one or both of the first transmission link and the second transmission link;
a same frequency and a same cell identifier being allocated to the set of nodes for the transmission of data in the first transmission link; and
different cell identifiers being allocated to respective node in the set of nodes for the transmission of data in the second transmission link.

30. The method according to claim 29, further comprising using the one or both of the first transmission link and the second transmission link depending on the operations to be performed, wherein the first transmission link is configured to be used for operations with critical time requirements, and wherein the second transmission link is configured to be used for operations with non-critical time requirements.

31. The method according to claim 29, wherein the first transmission link is configured to be used for mobility operations when the device is transitioning from a coverage area of one node into a coverage area of a neighbouring node in the set of nodes.

32. The method according to claim 31, wherein the mobility operations comprise handover between nodes in the set of nodes.

33. The method according to claim 30, wherein the critical time requirements comprise hard time requirements for enabling a seamless handover between nodes in the set of nodes.

34. The method according to claim 29, wherein the second transmission link is configured to be used for operations when the device is transmitting data independently in a coverage area of one node in the set of nodes.

35. The method according to claim 29, wherein the first transmission link and the second transmission link are configured to be used in parallel depending on the operations to be performed.

36. The method according to claim 29, wherein the first transmission link is scalable depending on the operations to be performed.

37. The method according to claim 29, wherein the method further comprises determining the operations to be performed by the one or both of the device and the set of nodes.

38. The method according to claim 29, wherein the method further comprises allocating an amount of bandwidth to respective node in the set of nodes based on the operations to be performed.

39. The method according to claim 29, wherein the device and the set of nodes are configured to signal their multi-link multi-node capabilities to other devices and nodes in the wireless network.

40. A non-transitory computer storage medium, having thereon a computer program comprising program instructions, the computer program being loadable into a data processing unit and configured to execute a method for multi-link transmission in a wireless network comprising a device and multiple nodes, each node defining a corresponding coverage area and being configured to perform operations in the wireless network, the device being configured to transition between the nodes and corresponding coverage areas and perform operations in the wireless network, when the computer program is run by the data processing unit, the method comprising:
transmitting data between the device and a set of the nodes using a multi-link connection, the multi-link comprising a first transmission link and a second transmission link associating the device with the set of nodes;
using the one or both of the first transmission link and the second transmission link;
a same frequency and a same cell identifier being allocated to the set of nodes for the transmission of data in the first transmission link; and
different cell identifiers being allocated to respective node in the set of nodes for the transmission of data in the second transmission link.
